(19) United States
(12) Patent Application Publication
(10) Pub. No.: US 2024/0354766 A1
(43) Pub. Date: Oct. 24, 2024

(54) AUTOMATED ANOMALY DETECTION USING MACHINE LEARNING AND BINARY POINT ANOMALY METHODS

(71) Applicant: WORKDAY, INC., Pleasanton, CA (US)

(72) Inventors: Riyaz KASMANI, Fremont, CA (US); Daniel ALVAREZ, East Elmhurst, NY (US); Monika PANDEY, Pune (IN)

(21) Appl. No.: 18/302,256

(22) Filed: Apr. 18, 2023

(51) Int. Cl. G06Q 20/40

(52) U.S. Cl. CPC G06Q 20/4016

(57) ABSTRACT

In some aspects, the techniques described herein relate to a method including: receiving, by a processor, raw data representing interactions of a set of users stored in a database; analyzing, by the processor, the raw data to identify an aggregate number of binary point anomalies (BPAs) for each user in the set of users; weighting, by the processor, the aggregate number of BPAs for each user in the set of users using a pre-configured weighting vector, generating a set of weighted BPA values for each user; aggregating, by the processor, each set of weighted BPA values for each user to generate corresponding total scores for each user; and displaying, by the processor, the corresponding total scores.

### BACKGROUND

Many data-driven systems rely on auditors to verify the integrity of stored data (e.g., verify compliance with company policies, identify process gaps, and identify malicious behavior). Many systems rely on sampling large datasets to perform this function: selecting a representative subset of all records and manually performing auditing on the subset.

Such an approach inherently fails to capture nuances in datasets that are not amenable to per-user analysis and are limited, at best, to capturing transaction-level problems. Specifically, existing systems cannot reliably determine if individual users are engaged in risky transactions spanning a time window. Such current approaches often enable users to “hide” anomalous transactions by spreading the transactions over a period. Thus, existing systems cannot reliably detect such longer-term behavior and instead focus on identifying singular, risky transactions while ignoring longer term anomalous trends.

In such systems, scaling is infeasible. That is, scaling such systems requires further human review and analysis, which is often impossible given the processing time requirements of large datasets.

### BRIEF DESCRIPTION OF THE FIGURES

FIG. 1 is a block diagram illustrating a system for generating risk scores for data records according to some of the example embodiments.

FIG. 2 is a block diagram of a risk scorer according to some of the example embodiments.

FIG. 3 is a flow diagram illustrating a method for assigning a risk score to a user according to some of the example embodiments.

FIG. 4 is a flow diagram illustrating a method for generating an aggregated binary point anomaly score according to some of the example embodiments.

FIG. 5 is a block diagram of a computing device according to some embodiments of the disclosure.

### DETAILED DESCRIPTION

The example embodiments remedy the aforementioned problems by assigning risk scores to users associated with data records.

In the various embodiments, a risk engine is described that includes a risk scorer that reads data records from a raw data source and generates risk scores for each user. In some embodiments, the risk scorer can include a feature generator for converting raw data records into feature sets. The feature generator can use deterministic logic to synthesize new features from the raw data. For example, the feature generator can generate numerical features from categorical raw data variables. The feature generator can output a data record's feature set to one or more ML models, one or more binary point anomaly detectors (BPADs), and one or more statistical scoring modules. In an embodiment, the ML model can predict a score for a user based on aggregated predictions of user-related records. In various embodiments, the ML model can comprise an autoencoder network, isolation forest, or histogram-based outlier model (although other models may be contemplated). The BPAD can comprise a device that detects anomalous events in a set of user records and weights and normalizes these occurrences across all users. Finally, a statistical scoring module can empirically score a user based on data in transactions. Each of the scores may be combined or aggregated and displayed, along with an explanation of how the score was generated.

In contrast to existing approaches, the example embodiments can operate on all (or most) data records in a dataset and provide risk scores for every user based on a combination of binary point anomalies, a trained ML model, and flexible entity-specific rules. Further, unlike pure ML approaches to anomaly detection, the example embodiments can be tuned based on the overall risk of an anomaly to an organization.

In some aspects, the techniques described herein relate to a method including: receiving, by a processor, raw data representing interactions of a set of users stored in a database; analyzing, by the processor, the raw data to identify an aggregate number of binary point anomalies (BPAs) for each user in the set of users; weighting, by the processor, the aggregate number of BPAs for each user in the set of users using a pre-configured weighting vector, generating a set of weighted BPA values for each user; aggregating, by the processor, each set of weighted BPA values for each user to generate corresponding total scores for each user; and outputting, by the processor, the corresponding total scores.

In some aspects, the techniques described herein relate to a method, wherein receiving raw data representing interactions of a set of users includes receiving a set of records recorded over a historical time window.

In some aspects, the techniques described herein relate to a method, wherein analyzing the raw data to identify an aggregate number of binary point anomalies includes computing a vector for each user, the vector having a dimensionality equal to the number of BPAs and the values within the vector including a count of how many times a given user is associated with a respective BPA.

In some aspects, the techniques described herein relate to a method, wherein prior to weighting the aggregate number of BPAs, the method further includes normalizing the aggregate number of BPAs for each user.

In some aspects, the techniques described herein relate to a method, wherein prior to output the corresponding total scores, the method further includes normalizing the corresponding total scores.

In some aspects, the techniques described herein relate to a method, further including, for a given user in the set of users, combining a corresponding total score with a machine learning (ML) score generated using a subset of the raw data and processed features associated with the given user, the ML score generated using an unsupervised learning algorithm.

In some aspects, the techniques described herein relate to a method, wherein the ML score is generated by scoring a set of features generated based on the subset of the raw data and processed features and averaging the scores to generate the ML score.

In some embodiments, the foregoing method embodiments may also be performed by a computing device or system or may be embodied in a non-transitory computer-readable storage medium tangibly storing computer program instructions implementing the method.

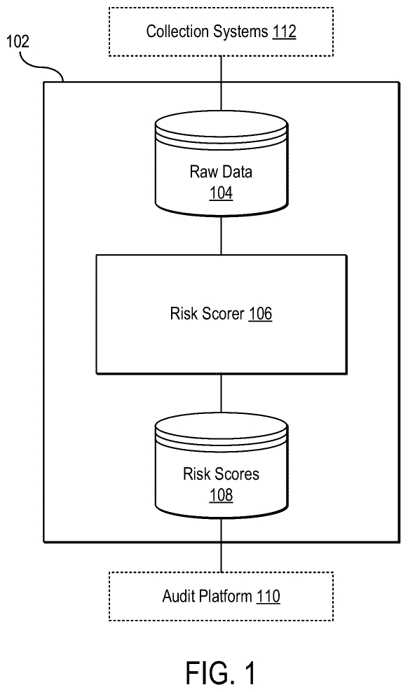

FIG. 1 is a block diagram illustrating a system for generating risk scores for data records according to some of the example embodiments.

In an embodiment, a system includes a risk engine 102 that receives data from collection systems 112 and stores the data in raw data store 104. Periodically, a risk scorer 106 in risk engine 102 can read raw data records from raw data store 104 and output risk scores for each raw data record to a risk score store 108. Subsequently, downstream applications, such as audit platform 110, can use the risk scores stored in risk score store 108 for further operations.

In some embodiments, the risk engine 102 can be included in an existing computing system. For example, collection systems 112 can comprise any type of computing system or network that can collect data associated with users. As one example, the collection systems 112 can comprise an expense reporting system that allows users or computing devices to enter details of expense data records for an organization. Such expense data records can include, for example, line-item details, a report number, a category for the expense, an amount value, etc. While expenses records are periodically used as examples, the disclosure is not limited as such, and any type of user data records that can include anomalous data points may also be used as input data for risk engine 102.

In some embodiments, the collection systems 112 can periodically write data to the raw data store 104. In some embodiments, the raw data store 104 can comprise any type of persistent data storage device. For example, the raw data store 104 can comprise a relational database, NoSQL database, flat file, key-value database, big data storage device, etc. In some embodiments, the raw data store 104 can comprise a canonical data source and thus may only be one-time writable by collection systems 112. In some embodiments, the risk scorer 106 may not be allowed to modify data stored in raw data store 104. Thus, the raw data store 104 may be read-only for risk scorer 106.

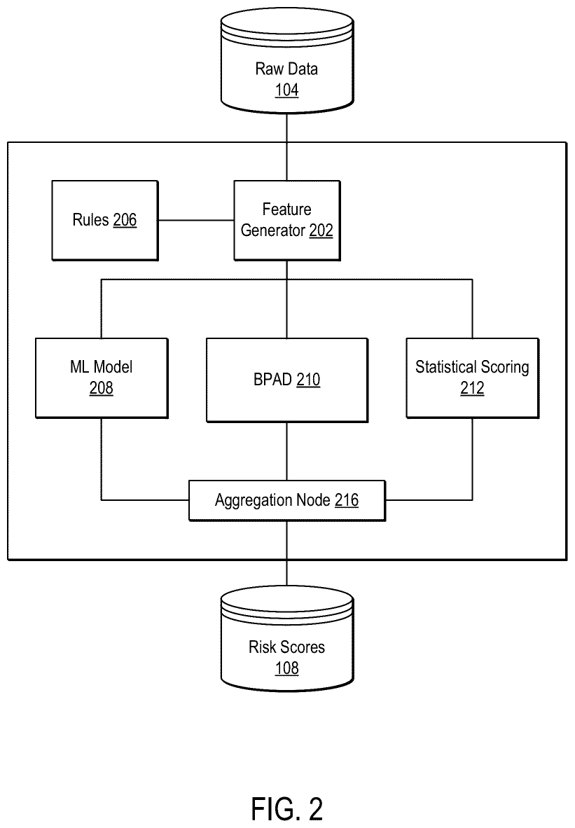

In an embodiment, the risk scorer 106 is configured to periodically read raw data records associated with users from raw data store 104 and generate corresponding risk scores for each user having data stored in raw data store 104. Specifically, structural and functional details of risk scorer 106 are described in more detail in the following FIGS. 2 through 4 and are not repeated herein but are incorporated in their entirety. In an embodiment, the risk scorer 106 ultimately outputs the generated risk scores to risk score store 108. In an embodiment, the risk score store 108 can comprise any type of persistent data storage device. For example, the risk score store 108 can comprise a relational database, NoSQL database, flat file, key-value database, big data storage device, etc. In some embodiments, the risk score store 108 can store only the risk scores and a reference (e.g., foreign key) to a user associated with raw data records stored in raw data store 104. For example, each user may have a unique identifier that can be used as the foreign key. In other embodiments, the risk scorer 106 can write the feature set used to generate a risk score along with the risk score to risk score store 108. In some embodiments, the risk scorer 106 can write the raw data, the feature set, and the risk score to risk score store 108.

As illustrated, downstream applications may access risk scores in risk score store 108 and provide further functionality built on top of the risk scores. For example, audit platform 110 can read risk scores for a set of users and present the original raw data and risk scores to a human auditor (e.g., via a web interface) for manual review. In some embodiments, since the risk scores may be stored in a structured storage device, the audit platform 110 can sort or otherwise order, group, filter, or organize the risk scores based on the needs of the audit platform 110. For example, the audit platform 110 can define a fixed risk score threshold and only provide those users having risk scores exceeding the threshold to a human reviewer. As another example, the audit platform 110 can sort the users based on the risk scores (e.g., highest score to lowest) and present the ordered users to a human reviewer, ensuring the human reviewer can view the users with the highest risk scores first. While the foregoing description focuses on auditing operations, other downstream operations that can utilize risk scores may also be implemented.

FIG. 2 is a block diagram of a risk scorer according to some of the example embodiments.

In an embodiment, a risk scorer 106 includes a feature generator 202, feature generation rules 206, ML model 208, binary point anomaly detector, BPAD 210, statistical scoring component 212, and an aggregation node 216. In some embodiments, the risk scorer 106 can be implemented as a collection of software modules executing on a computing device. In other embodiments, the various components of risk scorer 106 can be implemented as software, or hardware, implemented separately from other components (e.g., in a cloud-based deployment).

In an embodiment, the feature generator 202 can read one or more raw data records from raw data store 104 and convert the one or more raw data records to one or more feature vectors for use by ML model 208, BPAD 210, or statistical scoring component 212. The feature generator 202 can read multiple raw data records from raw data store 104. In some implementations, feature generator 202 may read a set of records associated with a single user. For example, feature generator 202 can extract all records having a same user identifier and processes these records for a given user. The feature generator 202 can do this for multiple users.

In an embodiment, the feature generator 202 converts raw data records into a feature set that includes a plurality of individual features. In some embodiments, the features can include a mix of categorical and numerical features. In other embodiments, the features may include only categorical features or only numerical features. As illustrated, the feature generator 202 outputs the feature set to ML model 208, BPAD 210, and statistical scoring component 212 for processing.

In an embodiment, some of the features generated by feature generator 202 can comprise raw features. In an embodiment, raw features comprise data in raw data records that is included, unchanged, in the feature set. For example, a dollar amount of an expense or a date may be included as a raw feature. In some embodiments, the feature generator 202 can be configured to select a subset of the raw features for including in the feature set (or for further processing, discussed next). For example, an operator of the system can select a small subset of raw features to seed the feature generator 202.

In an embodiment, the feature generator 202 can provide some or all the raw features to feature generation rules 206 to generate rule-based features. Feature generation rules 206 process the raw data to generate synthesized features, as will be discussed. In an embodiment, the feature generation rules 206 can apply procedural operations to raw features to obtain synthesized features. In an embodiment, these procedural operations may be stateless. That is, the rules can be applied in a repeatable manner to a given set of raw features. In some implementations, feature generation rules 206 can apply rules to a set of raw data records, generating per-user features using a set of raw data records associated with a single user.

As one example, the feature generation rules 206 can analyze a raw date feature and output a Boolean feature that indicates whether the raw date is a certain day of the week. As another example, the feature generation rules 206 can analyze a raw data record to determine if a receipt is missing from an expense entry and output a feature (e.g., a Boolean or integer value) indicating as such. As another example, the feature generation rules 206 can utilize a list of high-risk entities and output a feature (e.g., a Boolean or integer value), indicating whether the raw data record includes an identifier of an entity in the list of high-risk entities. As another example, the feature generation rules 206 can analyze the raw data records to determine if the raw data record reflects a cash withdrawal expense and output a feature (e.g., a Boolean or integer value) indicating as such. The foregoing examples are not intended to be limiting, and similar types of features can be generated.

In further embodiments, the feature generation rules 206 can also apply aggregate operations on not only a single raw data record but an entire corpus of data records. In these embodiments, the feature generation rules 206 can access a corpus of raw data records as well as the raw data record being processed by feature generator 202. The feature generation rules 206 can then generate aggregate measurements for the raw data record being processed by feature generator 202. As one example, a raw data record being processed by feature generator 202 may include a user identifier. The feature generation rules 206 can query the raw data store 104 to load a corpus of raw data records for the user identifier. In some embodiments, this query can be time-limited to a specific range of raw data records (e.g., the last year of raw data records). The feature generation rules 206 can then generate an aggregate value based on the corpus of raw data records. For example, the feature generation rules 206 can compute a total amount in the corpus, an average expense amount in the corpus, a distribution frequency of raw data records, etc. Similar operations can be performed on other fields (e.g., aggregation features for merchants, dates, etc.).

In an embodiment, the ML model 208, BPAD 210, and statistical scoring component 212 can receive a feature vector set generated by feature generator 202. As discussed, in some implementations, the ML model 208, statistical scoring component 212 and BPAD 210 may receive user-level feature vectors. In other embodiments, the ML model 208, BPAD 210, and statistical scoring component 212 can receive a subset of all the features generated by feature generator 202. Specifically, each of the ML model 208, BPAD 210, and statistical scoring component 212 can receive only those features necessary to generate an interim score (described below). In general, each of ML model 208, the BPADs, and statistical scoring component 212 will operate on a per-user basis although they may access other users to perform functions such as normalization.

In an embodiment, the ML model 208 is configured to receive a record-level feature set for a given user and generate a score. In general, the ML model 208 can comprise ensemble ML models configured to identify anomalous data records based on unknown risk factors or evolving practices in capturing the raw data records for a user. In some embodiments, the ML model 208 can comprise an ensemble of unsupervised ML models. In some embodiments, the output of the ML model 208 can comprise a measure of deviation from a “normal” data record (e.g., a data record having the most common or average features).

In an embodiment, the ML model 208 can include an autoencoder network. In an embodiment, the autoencoder network includes two components: an encoder network and a decoder network. In an embodiment, the encoder network comprises a set of hidden layers (and activation layer) that converts the feature set (i.e., vector) into a hidden representation vector, while the decoder network comprises a second set of hidden layers (and second activation layer) that converts the hidden representation into an approximation of the original feature set. In some embodiments, the autoencoder network can comprise a deep autoencoder network that includes multiple fully connected hidden layers. In some embodiments, the feature set received by ML model 208 can be converted into a purely numerical feature set via, as one example, one-hot encoding or similar techniques. In some embodiments, the autoencoder network can be trained on a rolling basis using feature sets generated from the raw data records in an unsupervised manner. In some embodiments, a given output of the autoencoder can be considered to indicate that the feature set is anomalous if the reconstruction error of the autoencoder is above a pre-configured threshold.

In another embodiment, the ML model 208 can include an isolation forest model. In an embodiment, the isolation forest model can predict the distance between a given feature set and other feature sets. In an embodiment, during prediction, the isolation forest model can recursively generate partitions on the feature set by randomly selecting a feature and then randomly selecting a split value for the feature, between the minimum and maximum values allowed for a given feature. In an embodiment, feature sets generated from existing raw data records can be used to build isolation trees using this recursive partitioning process. Then, during prediction, each feature set can be passed through the isolation trees built during training to generate a corresponding score.

In another embodiment, the ML model 208 can include a histogram-based outlier score (HBOS) model. When using an HBOS model, the ML model 208 can generate a histogram of potential values for each feature of a corpus of feature sets. In essence, an HBOS model computes the density or popularity of potential values for each feature in a feature set. As with isolation forests and autoencoders, a corpus of feature sets can be used to build the per-feature histograms. During prediction, a given feature set's features can be compared to the feature densities and given a score based on how closely each feature in the feature set it to the most popular corresponding value. In some embodiments, individual distances of features in a feature set can be summed to generate a score for the entire feature set.

In yet another embodiment, the ML model 208 can include multiple models. For example, the ML model 208 can include each of an autoencoder model, an isolation forest model, and an HBOS model. In such an embodiment, the outputs of each model can be aggregated to form a score. In some embodiments, the outputs of each model can further be weighted and/or normalized to a common scale before aggregating. In some embodiments, a linear regression model can be used to weight the outputs of each model.

In some implementations, for a given user, the average score for all records associated with a user predicted by ML model 208 can be averaged to form a per-user ML risk score. That is, while the ML model 208 may score each record in isolation, each record for a given user is aggregated (e.g., averaged) to form a per-user ML risk score.

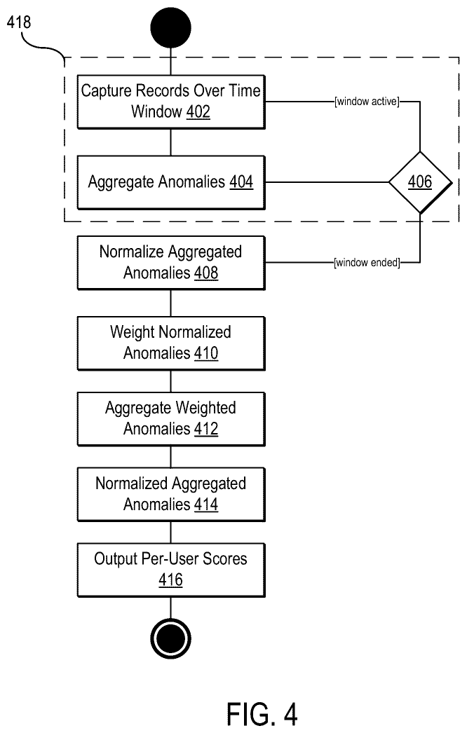

In an embodiment, the risk scorer 106 also includes BPAD 210. As with ML model 208, the BPADs receive a feature set (or a subset thereof) of users and output scores. In some implementations, a given BPAD can be configured to analyze a set of records for a user and compute a risk score for a given user based on the number of BPAs associated with a user. In general, BPAD 210 will be configured to detect a count of how many types of BPAs occur in a user's feature set. The BPAD 210 will then weight, aggregate, and normalize these counts to generate a BPA score for a given user. Details of an example embodiment of this process are described in FIG. 4 and not repeated herein.

In addition to BPAD 210, the risk scorer 106 can include statistical scoring component 212. In some embodiments, the statistical scoring component 212 operates like BPAD 210 (e.g., performing a linear operation on a feature set or feature value). As one example, an operator may use a scoring function that linearly transforms a total cost feature of the feature set given its importance to the operator in defining an anomaly. Although one statistical scoring component 212 is illustrated, multiple may be used.

In an embodiment, the aggregation node 216 aggregates the score output computed by the ML model 208, the BPA score output by BPAD 210, and any score outputs generated by statistical scoring component 212. The aggregation node 216 can perform a summation, weighted summation, or similar operation. In some embodiments, the aggregation node 216 can also perform an optional sigmoid operation or similar normalizing operation. In an embodiment, the output of the aggregation node 216 can comprise the risk score of the feature set, which is ultimately persisted to risk score store 108 (as discussed in FIG. 1).

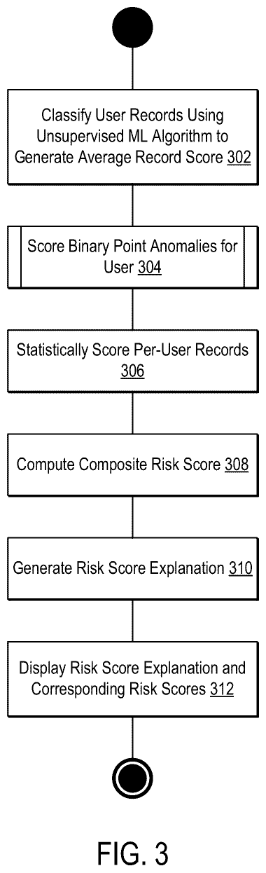

FIG. 3 is a flow diagram illustrating a method for assigning a risk score to a user according to some of the example embodiments.

In step 302, the method can include classifying user records using an unsupervised ML model to generate an average per-user record score.

In an embodiment, the ML model can be configured to receive a feature set and generate a score. In general, the ML model can include an ensemble ML model configured to identify anomalous data records based on unknown risk factors or evolving practices in capturing the raw data records. In some embodiments, the ML model can comprise an ensemble of unsupervised ML models. In some embodiments, the output of the ML model can comprise a measure of deviation from a “normal” data record (e.g., a data record having the most common or average features).

In an embodiment, the ML model can include an autoencoder network, isolation forest model, or HBOS model. Details of these various types of models were provided previously in the description of FIG. 2 and are not repeated herein. In yet another embodiment, the ML model can include multiple models. For example, the ML model can include each of an autoencoder model, an isolation forest model, and an HBOS model. In such an embodiment, the outputs of each model can be aggregated to form an interim score. In some embodiments, the outputs of each model can further be weighted and/or normalized to a common scale before aggregating. In some embodiments, a linear regression model can be used to weight the outputs of each model.

In some implementations, for a given user in the set of users, a subset of the raw data associated with a given user can be input into the ML model. In some implementations, the ML model can store a set of feature vectors generated using the subset of the raw data to generate scores for each of the feature vectors. Then, these scores can be averaged to generate an ML score for the given user. As discussed previously, this process can be done for multiple users, generating ML scores for each user.

In step 304, the method can include scoring binary point anomalies for a given user. As discussed above, a binary point anomaly refers to a record (or set of records) associated with a user either triggering or not triggering an anomaly. For example, a binary point anomaly can be defined as a user making a transaction every day for a fixed period. As can be seen, such anomalies are binary in that they either occur or do not occur. In step 304, the method can include receiving raw data representing interactions of a set of users comprises receiving a set of records recorded over a historical time window. Next, the method can analyze the raw data to identify an aggregate number of binary point anomalies (BPAs) for each user in the set of users. In some implementations, the method can compute a vector for each user, the vector having a dimensionality equal to the number of BPAs and the values within the vector comprising a count of how many times a given user is associated with a respective BPA.

Next, the method can weight the aggregate number of BPAs for each user in the set of users using a pre-configured weighting vector, generating a set of weighted BPA values for each user. In some implementations, before weighting the method can include normalizing the aggregate number of BPAs for each user (e.g., using a min-max normalization). Next, the method can include aggregating each set of weighted BPA values for each user to generate corresponding total scores for each user. In some implementations, the weighted BPA values can be further normalized across users (e.g., using a min-max normalization). Further details on step 304 are provided in the description of FIG. 4 and not repeated herein.

In step 306, the method can include statistically scoring per-user records. In some implementations, this statistical scoring can comprise a numerical function or operation performed with respect to a set of user feature vectors. For example, if the feature vectors include an expense value, step 306 can include summing the total expense across all records for a user. In some implementations, the expense values can be weighted based on a quantized view of the expenses (e.g., expenses under $100 are weighted by 0.1, between $100 and $500 by 0.3, etc.). Although expense values are used as an example, any type of statistical value can be used and any type of weighting may be used. Once a given user's statistical score is computed it can be normalized (e.g., using min-max normalization) relative to other statistical scores for other users.

Thus, in step 302 through step 306 three scores for each user are generated. First, in step 302, an ML-based model scores each user transaction and averages the user's own transactions to obtain an averaged ML score. Next, in step 304, a user's binary point anomalies are scored and normalized relative to other users. Then, in step 306, a user's statistical scores are normalized relative to other users.

In step 308, the method can include computing a composite risk score for a given user. In some implementations, step 308 can include aggregating the score output computed by the ML model (step 302), the BPA scores (step 304), and any statistical scores (step 306). In step 308, method can perform a summation, weighted summation, or similar operation. In some embodiments, method can also perform an optional sigmoid operation or similar normalizing operation as part of step 308. In an embodiment, the output of step 308 can comprise the risk score of a user, which is ultimately persisted to the risk score store.

In step 310, the method can include generating a risk score explanation. In some implementations, during the foregoing processing, the method can identify when a given score (before aggregation) exceeds a preconfigured threshold or, alternatively, contributes most to the final score. For example, since BPA scores may be normalized to a value between zero and one, those BPA scores that are within 0.8 and 1.0 may be flagged as high and used as an explanation for the risk score. Conversely, scores close to zero may not be flagged as they do not have a substantial impact on the composite risk score. In some implementations, each score for each user can further be assigned a percentile relative to the same score types for other users, thus enabling explanation based on high-percentile risk scores. In some implementations, labels may be stored based on the above analysis and recorded along with the final composite risk score. Alternatively, or in conjunction with the foregoing, the interim scores (e.g., ML score, individual ML feature scores, BPA scores, statistical scores) may also be stored along with the composite risk score which can enable reconstruction of the explanation after processing.

In an embodiment, method can ultimately output the generated risk scores and explanation to a risk score store. In an embodiment, the risk score store can comprise any type of persistent data storage device. For example, the risk score store can comprise a relational database, NoSQL database, flat file, key-value database, big data storage device, etc. In some embodiments, method can output only the risk scores and a reference (e.g., foreign key) to the corresponding raw data record stored in the raw data store to the risk score store. In other embodiments, method can write the feature set used to generate a risk score along with the risk score to the risk score store. In some embodiments, method can write the raw data, the feature set, and the risk score to the risk score store.

In step 312, the method can include displaying the risk score explanation and corresponding risk scores.

In some implementations, a dashboard or other front-end server and application may query the risk score store and retrieve user identifiers and composite risk scores. In some implementations, the risk score store can also provide the explanations or underlying interim scores. In response, the dashboard or similar application can render a display outputting the user risk scores and explanations to a human auditor or similar person.

In some implementations, the risk scores can be used to update a user profile or other data structure with a user scored using the above method. For example, each user scored using the above method may be represented in a database as a record including various data (e.g., demographic data) of the user. This record may be linked to other applications in a system (e.g., payment authorization systems, travel systems, etc.). In some implementations, a user may authenticate and be associated with a given user profile when accessing such systems. In response, the systems may access the user profiles prior to performing an action and determine whether to authorize a given action based on the score generated using the methods described herein. As one example, a travel system may allow users to book travel arrangements. If a high risk score for a user attempting to use this travel system exists, the travel system can use this risk score to either reduce the total amount available to spend on travel or to block the user entirely since they are associated with a high risk score. Such a system can thus dynamically and selectively modify its operations based on the risk scores generated using the foregoing method.

In some implementations, the foregoing scoring methodology may be used to assign scores to entities or organizations. That is, while the foregoing description emphasizes generating risk scores for a user based on their transactions in other implementations, an entity or organization may be scored using the same techniques. Such an application can allow for the scoring of organizations (e.g., vendors or suppliers) to generate a risk score caused by, for example, duplicate invoices, large dollar amounts, infrequent invoices, invoicing on old purchase orders with leftover amounts, etc. The foregoing embodiments can assign a risk score to the organization or entity, and then, based on the risk scores, all future invoices may be flagged for further review before being processed. In a related embodiment, a department or other subdivision of an organization can be scored using the foregoing embodiments. For example, expense transactions for a department of an organization may be used as input records to generate a risk score for a department which can flag future expenses of the department for further scrutiny. Alternatively, or in conjunction with the foregoing, flagging users, entities, or departments, the example embodiments may also include generate alerts or notifications of high-risk users, entities, or departments and transmit such alerts to the appropriate reviewer.

Similarly, such external systems may use the generated risk scores to generate and transmit notifications to a risk reviewer. In some implementations, the above method may be executed periodically and a notification (e.g., short message service (SMS), push notification, etc.) can be transmitted to the entity associated with high risk scores, including risk reviewers.

FIG. 4 is a flow diagram illustrating a method for generating an aggregated binary point anomaly score according to some of the example embodiments.

In step 402, the method can include capturing records over a time window or horizon. In some implementations, the time window may be specified by the operator of a system and may be, as examples, one month, one quarter, one year, etc. In some implementations, the records may be captured irrespective of the time window and step 402 may include querying a data store using a parameter to limit the returned records for a given time window. In some implementations, step 402 can include retrieving records for multiple users, while each record is individually associated with a user.

In step 404, the method can include aggregating binary point anomalies over the time window.

In some implementations, the method may use one or more BPAs that have triggering conditions. For example, a first BPA may specify that a first BPA occurs if a user spends over a certain amount for a pre-determined number of days in succession. Similarly, a second BPA may specify that a second BPA occurs when a user requests expense approval over a certain number of times over multiple days. The specific BPAs may certainly include any other type of binary point anomaly. Generally, a BPA refers to the fact that anomaly either does or does not occur given a set of records over time. Thus, any anomalous activity can be defined as a BPA and aggregated in step 404. In general, aggregation of BPAs may include determining if, and how many, BPAs occur within the time window for each user. In some implementations, aggregation can include counting the number of BPAs that occur. In some implementations, each BPA can be counted separately.

Consider, as a limited example, a system with four users (U1 through U4) and three BPAs (BPA1 through BPA3). In such a system, step 404 can include counting the number of times these anomalies occur to generate the following aggregate results:

TABLE 1

| User | BPA1 | BPA2 | BPA3 |
|---|---|---|---|
| U1 | 10 | 10 | 12 |
| U2 | 5 | 2 | 3 |
| U3 | 7 | 3 | 4 |
| U4 | 1 | 1 | 4 |

In step 406, the method can include determining if the time window has expired. If not, the method continues to execute step 402 and step 404 until the time window ends. The loop 418 may thus continue executing and aggregating anomalies until the time window expires. Certainly, in some implementations, the method can be re-executed once the time window expires and thus be executed continuously at intervals equal to the time window.

In step 408, when the time window ends, the method can include normalizing the aggregated anomalies to generate normalized anomalies. In some implementations, the normalization can be applied across all user scores for a given BPA. That is, each user may have its own aggregated BPA count. However, such a scale may vary widely across all users. Thus, in some implementations, each BPA is normalized across all users. Continuing the example of Table 1, a min-max normalization may be used to normalize each BPA to generate a set of normalized, aggregated anomalies:

TABLE 2

| User | BPA1 | BPA2 | BPA3 |
|---|---|---|---|
| U1 | 1.00 | 1.00 | 1.00 |
| U2 | 0.44 | 0.11 | 0.00 |
| U3 | 0.67 | 0.22 | 0.11 |
| U4 | 0.00 | 0.00 | 0.11 |

As illustrated in Table 2, each BPA aggregate score is normalized to be on a scale of zero to one for each BPA. Although min-max normalization is used as an example, other normalization techniques may be used such as z-score normalization, robust normalization, log transformation, decimal scaling, or softmax scaling.

In step 410, the method can include weighting the normalized anomalies to generate weighted anomalies. In some implementations, weights for each BPA can be manually defined by an operator. In some implementations, the weights may comprise arbitrary numeric values. In other implementations, the weights may be required to satisfy one or more conditions (e.g., they must total one). As an example, an operator may weight BPA1 as 3, BPA2 as 4, and BPA 5. After weighting using this example, Table 2 may be updated as follows:

TABLE 3

| User | BPA1 | BPA2 | BPA3 |
|---|---|---|---|
| U1 | 3.00 | 4.00 | 5.00 |
| U2 | 1.33 | 0.44 | 0.00 |
| U3 | 2.00 | 0.89 | 0.56 |
| U4 | 0.00 | 0.00 | 0.56 |

As illustrated, in some implementations, the weighting can comprise multiplying the weight by each normalized score. Other weighting techniques may also be used such as rank-based weighting, Bayesian weighting, etc.

In step 412, the method can include aggregating the weighted anomalies to generated aggregated anomalies. In some implementations, once the method weights each individual user-anomaly pair, the method can then aggregate all BPA scores associated with a user. For example, user U1's scores for BPA1, BP2, and BP3 may be aggregated (e.g., summed) to form a single BPA score. As illustrated below, continuing the example in Table 3, each user is then associated with a single score:

TABLE 4

| User | Total BPA Score |
|---|---|
| U1 | 12.00 |
| U2 | 1.78 |
| U3 | 3.44 |
| U4 | 0.56 |

As illustrated, a straight summation or summing of BPA scores is used. However, in other implementations, other aggregation techniques can be used (e.g., averaging). As in Table 1, the resulting aggregation may include a wide range of values, particularly when some users are more anomalous than others (e.g., U1).

In step 414, the method can include normalizing the aggregated anomalies to generate per-user scores. Specifically, as discussed above, the aggregated scores generated in step 412 may be sparse, having a few larger values and large number of values clustered around a mean. As such, in step 414, the method may apply a second normalization step similar to that of step 408. As in that step, step 414 can include performing a second min-max normalization or other similar normalization technique. Continuing the example in Table 4, the following table illustrates the final, normalized BPA score for each user:

TABLE 5

| User | Score |
|---|---|
| U1 | 1.00 |
| U2 | 0.11 |
| U3 | 0.25 |
| U4 | 0.00 |

As in step 408, each final user BPA score thus is within zero and one. In some implementations, this scale may be adjusted to match other scores such as the ML model score or statistical scoring score. For example, both such scores may also be normalized so that all scores are within zero and one.

In step 416, the method can include outputting the per-user BPA scores. In some implementations, the output may be used for aggregating with other scores (e.g., ML scores) as described more fully in step 308 which is not repeated herein.

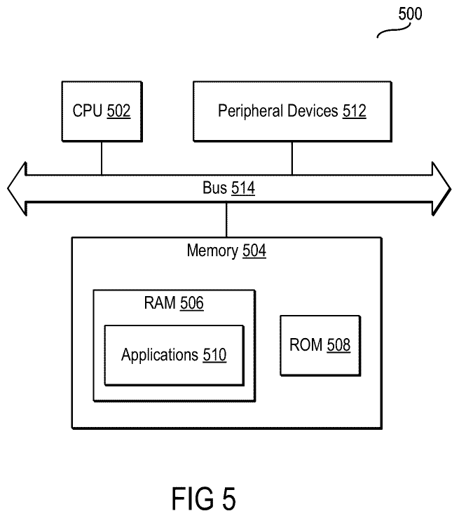

FIG. 5 is a block diagram of a computing device according to some embodiments of the disclosure.

In some embodiments, the computing device 500 can be used to perform the methods described above or implement the components depicted in the foregoing figures.

As illustrated, the computing device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a non-transitory memory system including a dynamic random-access memory (DRAM), static random-access memory (SRAM), Flash (e.g., NAND Flash), or combinations thereof. In one embodiment, bus 514 may comprise a Peripheral Component Interconnect Express (PCIe) bus. In some embodiments, bus 514 may comprise multiple busses instead of a single bus.

Memory 504 illustrates an example of non-transitory computer storage media for the storage of information such as computer-readable instructions, data structures, program modules, or other data. Memory 504 can store a basic input/output system (BIOS) in read-only memory (ROM), such as ROM 508, for controlling the low-level operation of the device. The memory can also store an operating system in random-access memory (RAM) for controlling the operation of the device

Applications 510 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The computing device 500 may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth™, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, the claimed or covered subject matter is intended to be broadly interpreted. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “or,” “and,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur in any order other than those noted in the illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a processor, raw data representing interactions of a set of users stored in a database;
analyzing, by the processor, the raw data to identify an aggregate number of binary point anomalies (BPAs) for each user in the set of users;
weighting, by the processor, the aggregate number of BPAs for each user in the set of users using a pre-configured weighting vector;
generating a set of weighted BPA values for each user;
aggregating, by the processor, each set of weighted BPA values for each user to generate corresponding total scores for each user; and
displaying, by the processor, the corresponding total scores.

2. The method of claim 1, further comprising controlling, by the processor, access to a network service for a given user based on a corresponding total score in the corresponding total scores.

3. The method of claim 1, wherein analyzing the raw data to identify an aggregate number of binary point anomalies comprises computing a vector for each user, the vector having a dimensionality equal to the number of BPAs and the values within the vector comprising a count of how many times a given user is associated with a respective BPA.

4. The method of claim 1, wherein prior to weighting the aggregate number of BPAs, the method further comprises normalizing the aggregate number of BPAs for each user.

5. The method of claim 1, wherein prior to output the corresponding total scores, the method further comprises normalizing the corresponding total scores.

6. The method of claim 1, further comprising, for a given user in the set of users, combining a corresponding total score with a machine learning (ML) score generated using a subset of the raw data and processed features associated with the given user, the ML score generated using an unsupervised learning algorithm.

7. The method of claim 6, wherein the ML score is generated by scoring a set of features generated based on the subset of the raw data and processed features and averaging the scores to generate the ML score.

8. A non-transitory computer-readable storage medium for tangibly storing computer program instructions capable of being executed by a computer processor, the computer program instructions defining steps of:
receiving, by the computer processor, raw data representing interactions of a set of users stored in a database;
analyzing, by the computer processor, the raw data to identify an aggregate number of binary point anomalies (BPAs) for each user in the set of users;
weighting, by the computer processor, the aggregate number of BPAs for each user in the set of users using a pre-configured weighting vector;
generating, by the computer processor, a set of weighted BPA values for each user;
aggregating, by the computer processor, each set of weighted BPA values for each user to generate corresponding total scores for each user; and
displaying, by the computer processor, the corresponding total scores.

9. The non-transitory computer-readable storage medium of claim 8, the steps further comprising controlling access to a network service for a given user based on a corresponding total score in the corresponding total scores.

10. The non-transitory computer-readable storage medium of claim 8, wherein analyzing the raw data to identify an aggregate number of binary point anomalies comprises computing a vector for each user, the vector having a dimensionality equal to the number of BPAs and the values within the vector comprising a count of how many times a given user is associated with a respective BPA.

11. The non-transitory computer-readable storage medium of claim 8, wherein prior to weighting the aggregate number of BPAs, the steps further comprise normalizing the aggregate number of BPAs for each user.

12. The non-transitory computer-readable storage medium of claim 8, wherein prior to output the corresponding total scores, the steps further comprise normalizing the corresponding total scores.

13. The non-transitory computer-readable storage medium of claim 8, the steps further comprising, for a given user in the set of users, combining a corresponding total score with a machine learning (ML) score generated using a subset of the raw data and processed features associated with the given user, the ML score generated using an unsupervised learning algorithm.

14. The non-transitory computer-readable storage medium of claim 13, wherein the ML score is generated by scoring a set of features generated based on the subset of the raw data and processed features and averaging the scores to generate the ML score.

15. A device comprising:
a processor; and
a storage medium for tangibly storing thereon logic for execution by the processor, the logic comprising instructions for:
receiving raw data representing interactions of a set of users stored in a database;
analyzing the raw data to identify an aggregate number of binary point anomalies (BPAs) for each user in the set of users;
weighting the aggregate number of BPAs for each user in the set of users using a pre-configured weighting vector;
generating a set of weighted BPA values for each user;
aggregating, each set of weighted BPA values for each user to generate corresponding total scores for each user;
displaying the corresponding total scores.

16. The device of claim 15, wherein the instructions further comprising controlling access to a network service for a given user based on a corresponding total score in the corresponding total scores.

17. The device of claim 15, wherein analyzing the raw data to identify an aggregate number of binary point anomalies comprises computing a vector for each user, the vector having a dimensionality equal to the number of BPAs and the values within the vector comprising a count of how many times a given user is associated with a respective BPA.

18. The device of claim 15, wherein the instructions further comprise normalizing the aggregate number of BPAs for each user prior to weighting the aggregate number of BPAs.

19. The device of claim 15, wherein the instructions further comprise normalizing the corresponding total scores prior to output the corresponding total scores.

20. The device of claim 15, the instructions further comprising, for a given user in the set of users, combining a corresponding total score with a machine learning (ML) score generated using a subset of the raw data and processed features associated with the given user, the ML score generated using an unsupervised learning algorithm.
